(19) United States
(12) Patent Application Publication
(10) Pub. No.: US 2008/0211639 A1
(43) Pub. Date: Sep. 4, 2008

(54) DOMESTIC APPLIANCE ARRANGEMENT

(75) Inventors: Jan Dienstuhl, Munich (DE); Guido Stromberg, Munich (DE); Yvonne Gsottberger, Taufkirchen (DE); Werner Weber, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 11/765,317

(22) Filed: Jun. 19, 2007

(30) Foreign Application Priority Data
Jun. 19, 2006 (DE) 10 2006 028 110.1

(51) Int. Cl. G08B 1/00

(52) U.S. Cl. 340/286.02

(57) ABSTRACT

Domestic appliance arrangement having a domestic appliance, which can communicate in accordance with a domestic appliance communication protocol, and an interface coupling device which is coupled to the domestic appliance. The interface coupling device includes a first interface, which provides communication in accordance with the domestic appliance communication protocol, a second interface, which provides communication in accordance with a semantic communication protocol, and a protocol conversion unit for mapping data encoded in accordance with the domestic appliance communication protocol onto data which encoded in accordance with the semantic communication protocol and/or for mapping data encoded in accordance with the semantic communication protocol onto data encoded in accordance with the domestic appliance communication protocol. The semantic communication protocol can be used to detect a domestic appliance connected to the interface coupling device and to semantically describe properties of the domestic appliance connected to the interface coupling device.

### BACKGROUND

The invention relates to a domestic appliance arrangement, an interface coupling device and a method for controlling precisely one domestic appliance.

In automation engineering in networked environments, different standards are used for networking terminals. It is desirable to link appliances to one encompassing communication standard.

### BRIEF DESCRIPTION OF THE DRAWINGS

In the drawings, identical reference symbols generally denote the same components throughout the various views. The drawings are not necessarily true to scale. Instead, the focus has generally been placed upon illustrating the principles of the invention. The description below describes various exemplary embodiments of the invention with reference to the following drawings, in which:

FIG. 1 shows an example of a conventional networked environment for different automation standards;

FIG. 2 shows a domestic appliance arrangement in accordance with a first embodiment of the invention;

FIG. 3 shows a domestic appliance arrangement in accordance with a second embodiment of the invention;

FIG. 4 shows a domestic appliance arrangement in accordance with a third embodiment of the invention;

FIG. 5 shows an example of a network in which the domestic appliance arrangement in accordance with the third embodiment of the invention is used;

FIG. 6 shows a domestic appliance arrangement in accordance with a fourth embodiment of the invention.

### DESCRIPTION

In automation engineering in networked environments, a wide variety of standards are used for networking terminals. Thus, by way of example, the standards EIB (European Installation Bus) in the field of home automation and EHS (European Home System) for controlling “white goods” may be used.

Particularly in modern home automation and when using domestic appliances, it is often desirable to monitor and/or control a plurality of appliances, e.g. within a house. By way of example, these appliances include heating installations, lighting installations, alarm installations, roller shutters or else domestic appliances in the “white goods” group, such as refrigerators, washing machines, dishwashers etc.

For this purpose, controllers for monitoring individual, more complex systems were first of all developed. Thus, by way of example, the control device in a heating installation is set up such that temperature sensors connected to the control device transmit a temperature value and the control device controls the heating power on the basis thereof.

However, such control is limited to the one system and does not normally allow further appliances to be incorporated.

To allow flexible networking and control of a plurality of appliances or appliance systems within the context of home automation, various bus systems with protocols geared to this have been developed which are also already in practical use. Known representatives of such bus systems are the EIB (European Installation Bus)/KNX, EHS (European Home System) and LCN (Local Control Network).

The networks based on different standards can be built and actuated separately from one another. The large number of existing standards which are used in home automation makes standard or central control of and communication or interaction between all the terminals involved, which are equipped with different standards, difficult.

Linking appliances which are equipped in accordance with one of the aforementioned standards (for example EIB or EHS) to one encompassing communication standard, for example Universal Plug and Play (UPnP), which allows semantic description of the individual appliances and standard control and communication between the appliances in different networks, is conventionally possible only using a gateway architecture.

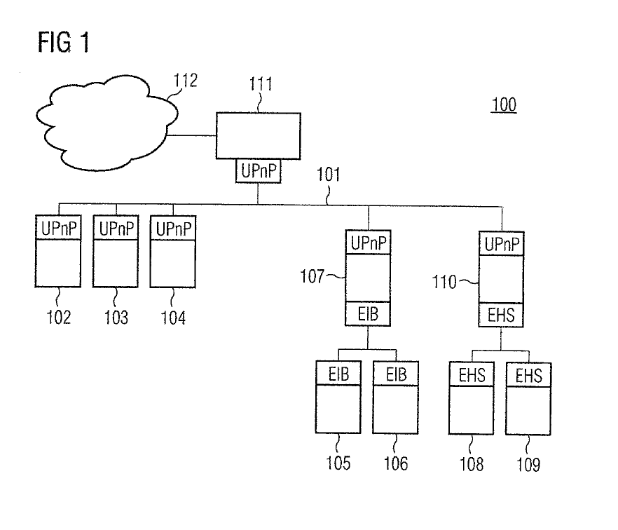

The network 100 shown in FIG. 1 is such an example of a conventional networked environment for different automation standards. As FIG. 1 shows, decentralized bridges (FIG. 1 shows an EIB-UPnP bridge 107 and an EHS-UPnP bridge 110 by way of example) can be used in order to map one network standard onto another. The bridges 107 and 110 have appliances connected to them, which are compatible with one particular standard (e.g. EIB or EHS), in order to make them available in one encompassing network standard (e.g. UPnP, Universal Plug and Play).

Thus, the configuration shown in FIG. 1 exhibits a UPnp network 101 which firstly incorporates a computer 102, an audio/video centre 103 and a Voice-over-IP appliance 104, which are actually able to communicate in accordance with the UPnP standard. Secondly, the UPnP network 101 has a lamp 105 and a television set 106, which communicate in accordance with the EIB standard, connected to it by means of the EIB-UPnP bridge 107 and has a washing machine 108 and a refrigerator 109, which communicate in accordance with the EHS standard, connected to it by means of the EHS-UPnP bridge 110. In addition, the UPnP network 101 is coupled by means of a gateway 111 to a wide area network (WAN), for example the Internet 112, as a result of which the UPnP network 101 can also communicate beyond its limits with other networks by means of the Internet 112.

The aforementioned bridges 107 and 117 are cost-intensive, however, and increase the complexity of the network which is to be installed. In addition, the fact that a plurality of appliances are connected on a bridge means that they represent a node, with the result that a malfunction in the bridge would cause all the connected appliances to become inoperable or to fail. On the other hand, it cannot be expected that the domestic appliances will without exception all be equipped such that they can be integrated as subscribers in a higher communication network involving a semantic protocol (e.g. based on UPNP) such that they can be managed and controlled by means of a web browser which runs on a computer integrated in the communication network, for example. Thus, in the case of UPnP, the relevant appliance would need to be able to process XML data (XML: Extensible Markup Language) and to process appropriate protocols, used by UPnP, from higher ISO-OSI layers, for example. This requires considerable computation power which needs to be provided by the respective domestic appliance, resulting in increased production costs and increased power consumption. This is unacceptable particularly for domestic appliances whose equipment means that they are actually not able to provide a corresponding processing (computation) power and which would therefore need to be equipped with computation power additionally as appropriate.

A domestic appliance arrangement in accordance with one exemplary embodiment of the invention has precisely one domestic appliance, which is set up for communication in accordance with a domestic appliance communication protocol, and an interface coupling device which is associated with the precisely one domestic appliance and which is coupled to the one domestic appliance. In this arrangement, the interface coupling device has a first interface, which is used to provide communication in accordance with the domestic appliance communication protocol, a second interface, which is used to provide communication in accordance with at least one semantic communication protocol, and a protocol conversion unit for mapping data which have been encoded in accordance with the domestic appliance communication protocol onto data which have been encoded in accordance with the at least one semantic communication protocol and/or for mapping data which have been encoded in accordance with the at least one semantic communication protocol onto data which have been encoded in accordance with the domestic appliance communication protocol. In this case, the semantic communication protocol is set up such that it can be used to detect at least one domestic appliance connected to the interface coupling device and such that properties of at least one domestic appliance connected to the interface coupling device can be described semantically.

In accordance with another exemplary embodiment of the invention, a combination of a domestic appliance which communicates and is controlled in accordance with a domestic appliance communication protocol and an interface coupling device is provided in a one-to-one association such that precisely one domestic appliance has an associated interface coupling device which performs protocol conversion from the domestic appliance communication protocol to a semantic communication protocol and vice versa, the semantic communication protocol being set up such that it is used to detect the connected domestic appliance and can be used to semantically describe it in order to make it known with its properties in a network environment in which communication is effected in accordance with the semantic communication protocol.

A domestic appliance arrangement in accordance with another exemplary embodiment of the invention allows a domestic appliance connected to the interface coupling device via the first interface to be identified in a network environment using the second interface of the interface coupling device. The one-to-one association of the domestic appliance and the interface coupling device ensures that in the event of a fault in the interface coupling device only the one domestic appliance coupled to this interface coupling device is affected, for example such that it is no longer identified in the network environment.

An interface coupling device in accordance with one exemplary embodiment of the invention has: a first interface, which is used to provide communication in accordance with the domestic appliance communication protocol, a second interface, which is used to provide communication in accordance with at least one semantic communication protocol, and a protocol conversion unit for mapping data which have been encoded in accordance with the domestic appliance communication protocol onto data which have been encoded in accordance with the at least one semantic communication protocol and/or for mapping data which have been encoded in accordance with the at least one semantic communication protocol onto data which have been encoded in accordance with the domestic appliance communication protocol. In this case, the semantic communication protocol is set up such that it can be used to detect at least one domestic appliance connected to the interface coupling device and to semantically describe properties of at least one domestic appliance connected to the interface coupling device.

A method for controlling precisely one domestic appliance in a domestic appliance arrangement comprising the precisely one domestic appliance and an interface coupling device which is associated with the precisely one domestic appliance in accordance with another exemplary embodiment of the invention has the following steps:

The domestic appliance is coupled to the interface coupling device via a communication interface of the domestic appliance and a first interface of the interface coupling device, this coupling allowing communication between the domestic appliance and the interface coupling device.

In addition, communication based on at least one semantic communication protocol via a second interface provided on the interface coupling device is used to detect at least one domestic appliance connected to the interface coupling device and to semantically describe properties of at least one domestic appliance connected to the interface coupling device.

Furthermore, a protocol conversion unit is used to map data which have been encoded in accordance with the domestic appliance communication protocol onto data which have been encoded in accordance with the at least one semantic communication protocol and/or to map data which have been encoded in accordance with the at least one semantic communication protocol onto data which have been encoded in accordance with the domestic appliance communication protocol.

Finally, the protocol conversion unit is coupled to the first interface and to the second interface, and a communication link is set up between the domestic appliance and the second interface via the communication interface of the domestic appliance and the first interface of the interface coupling device.

In accordance with another exemplary embodiment of the invention, a domestic appliance is a household appliance, for example, such as a refrigerator, a stereo system, a dishwasher, a washing machine, a laundry drier, a microwave oven, a cooker, a lighting system or a heating system.

In accordance with another exemplary embodiment of the invention, the protocol conversion unit has a memory device for storing a protocol conversion program code and also a processor which is set up such that it can execute the protocol conversion program code. In this case, the execution of the protocol conversion program code implements the mapping of data which have been encoded in accordance with the domestic appliance communication protocol onto data which have been encoded in accordance with the at least one semantic communication protocol and/or the mapping of data which have been encoded in accordance with the at least one semantic communication protocol onto data which have been encoded in accordance with the domestic appliance communication protocol. This means software-based implementation of the protocol conversion with the effect that new writing/replacement of the memory device allows implementation of matching to different protocol conversions. If the domestic appliance coupled to the protocol conversion unit is to be used in a new network environment, for example, in which communication is based on a semantic communication protocol which differs from the one used previously, replacement of the protocol conversion program code allows the domestic appliance to be matched to the new network environment.

In accordance with another exemplary embodiment of the invention, alterations which are made to the domestic appliance communication protocol can be taken into account by a piece of software matched thereto, i.e. a suited protocol conversion program code.

This ensures a high degree of flexibility for the protocol conversion unit.

In accordance with another exemplary embodiment of the invention, the semantic communication protocol used to implement the functionality described above is a protocol based on the Universal Plug and Play (UPNP) standard, for example. UPnP is based on a series of standardized network protocols and data formats and is used for cross-manufacturer actuation of appliances via an IP-based network. In accordance with this standard, the at least one semantic communication protocol is the Simple Service Discovery Protocol (SSDP), for example. An appliance uses SSDP (e.g. uses an ssdp:alive report) to provide notification of its presence in a network. HTTP (based on TCP and IP) is used to supply the description of the connected appliance, and the appliance provides this description in the form of an XML document.

In accordance with another exemplary embodiment of the invention, the at least one semantic communication protocol is also set up such that it is used to provide at least one additional function for controlling the domestic appliance. Besides the appliance identifier and semantic description (see above), the semantic communication protocol is therefore able to support control of the domestic appliance.

In accordance with another exemplary embodiment of the invention, the at least one semantic communication protocol is set up in accordance with a UPnP standard which implements the functions of Control and Eventing in accordance with UPnP. These two functions implement the actual control of an appliance in a UPnP environment.

In accordance with another exemplary embodiment of the invention, the Simple Object Access Protocol (SOAP) is used for the Control function and the XML-based General Event Notification Architecture (GENA) is used for the Eventing function, for example.

SOAP is used to send messages for controlling an appliance to the control URL of the relevant appliance. GENA is used to inform control points (other appliances) in the network about events on the appliance. Thus, the control points receive the respective new value upon every change in a status variable for the appliance which is to be controlled.

In accordance with another exemplary embodiment of the invention, the protocol conversion unit may be set up such that it can execute a domestic appliance control program stored in the memory device for controlling the domestic appliance via the first interface.

In accordance with another exemplary embodiment of the invention, the domestic appliance control program may clearly be a piece of application software for the respective domestic appliance which is used to control the functional sequence of the domestic appliance. By way of example, the storage and execution of the domestic appliance control program outside the domestic appliance (in the protocol conversion unit) has the effect that the domestic appliance itself does not need to be equipped with complex computer technology and that the domestic appliance control program is easy to update.

In accordance with another exemplary embodiment of the invention, the memory device may have a first submemory and a second submemory, with the first submemory storing the protocol conversion program code and the second submemory storing the domestic appliance control program.

The use of two separate memories simplifies the independent updating of the protocol conversion program code and the code of the domestic appliance control program or the independent replacement of the memory for the protocol conversion program code and the memory for the domestic appliance control program.

In accordance with another exemplary embodiment of the invention, the interface coupling device is set up such that the protocol conversion unit has an initialization unit which is set up such that it can be used to detect at least one domestic appliance connected to the interface coupling device using the second interface and to semantically describe properties of at least one domestic appliance connected to the interface coupling device.

In accordance with another exemplary embodiment of the invention, the protocol conversion unit has a first memory device for storing a protocol conversion program code. In addition, the interface coupling device in this exemplary embodiment has a first protocol conversion program code transmission interface which is set up to the transmit the protocol conversion program code to an external protocol conversion unit. In other words, that is to say that the protocol conversion program code, which is responsible for the protocol conversion, is not executed in the protocol conversion unit itself but rather is transported from the first memory device via the first protocol conversion program code transmission interface to an external protocol conversion unit, with the initialization unit causing the basic functions of the appliance identifier and of the semantic appliance description to be maintained.

In accordance with another exemplary embodiment of the invention, the interface coupling device has a third interface which is used to provide communication in accordance with the domestic appliance communication protocol between the interface coupling device and an external protocol conversion unit.

That is to say that the protocol conversion unit arranged in the domestic appliance's interface coupling device communicates in accordance with the domestic appliance communication protocol, except for the aforementioned functions of the appliance identifier and the semantic appliance description, and does not perform protocol conversion itself. This has the effect, by way of example, that the interface coupling device or the protocol conversion unit does not need to provide a large amount of computation power and therefore a small and energy-saving design for the domestic appliance's interface coupling device can be implemented.

In accordance with another exemplary embodiment of the invention, the first memory device may also have a domestic appliance control program stored therein for controlling the domestic appliance, and the first protocol conversion program code transmission interface may also be set up to transmit the domestic appliance control program to the external protocol conversion unit.

In other words, in accordance with this exemplary embodiment of the invention, the first memory device may store a domestic appliance control program, as has already been mentioned above in connection with another exemplary embodiment, but this is not executed in the protocol conversion unit of the domestic appliance's interface coupling device but rather is transmitted to the external protocol conversion unit.

In accordance with another exemplary embodiment of the invention, the first memory device has a first submemory and a second submemory, for example, the first submemory storing the protocol conversion program code and the second submemory storing the domestic appliance control program.

By way of example, this has the effect that the protocol conversion program code and the domestic appliance control program can be stored in separate memories and hence the memories can be replaced separately, for example.

In accordance with another exemplary embodiment of the invention, the semantic communication protocol used for implementing the functionality described above may be a protocol in accordance with the Universal Plug and Play (UPNP) standard, for example the Simple Service Discovery Protocol (SSDP). In this regard, reference may be made to the statements above in respect of other exemplary embodiments of the invention.

In accordance with another exemplary embodiment of the invention, the external protocol conversion unit also has a second protocol conversion program code transmission interface, which is set up to receive the protocol conversion program code from the interface coupling device, a fourth interface, which is used to provide communication in accordance with the domestic appliance communication protocol, and a second memory device for storing the received protocol conversion program code.

In accordance with another exemplary embodiment of the invention, the external protocol conversion unit may have a processing device which is set up such that it can execute the received protocol conversion program code, where the execution of the protocol conversion program code implements the mapping of data which have been encoded in accordance with the one or more domestic appliance communication protocol(s) onto data which have been encoded in accordance with the one or more semantic communication protocol(s) and/or the mapping of data which have been encoded in accordance with the one or more semantic communication protocol(s) onto data which have been encoded in accordance with the domestic appliance communication protocol, and where at least one of the one or more semantic communication protocols is also set up such that it is used to provide at least one additional function for controlling the domestic appliance.

In accordance with another exemplary embodiment of the invention, the external protocol conversion unit may have a fifth interface which is used to provide communication in accordance with the one or more semantic communication protocol(s).

In other words, in accordance with one exemplary embodiment of the invention, the external protocol conversion unit is used to implement relocation of the protocol conversion from the domestic appliance's interface coupling device to the external protocol conversion unit. This technique relocates computation-intensive processing operations of protocol conversion to the external protocol conversion unit.

As described above, the at least one semantic communication protocol is set up, in accordance with one exemplary embodiment of the invention, in accordance with a UPnP standard, for example, which implements the functions of Control and Eventing based on UPnP, the at least one semantic communication protocol comprising the Simple Object Access Protocol (SOAP) and the General Event Notification Architecture (GENA), for example. In this regard, reference is made to the statements above in respect of other exemplary embodiments of the invention.

In accordance with another exemplary embodiment of the invention, the external protocol conversion unit is further set up such that the second protocol conversion program code transmission interface is further set up to receive the domestic appliance control program for the interface coupling device, the second memory device stores the received domestic appliance control program, and the processing device can execute the domestic appliance control program for controlling the domestic appliance via the fourth, third and first interfaces.

In other words, in accordance with this exemplary embodiment of the invention, the execution of a domestic appliance control program is also relocated to the external protocol conversion unit.

In accordance with another exemplary embodiment of the invention, the external protocol conversion unit is a workstation, a personal computer, a laptop, a webpad, a personal digital assistant or a mobile radio telephone, for example.

In accordance with another exemplary embodiment of the invention, the external protocol conversion unit is an apparatus which has sufficient computation power and storage capacity.

In accordance with exemplary embodiments of the invention, the incorporation of a household appliance which is set up in accordance with a particular communication standard into an encompassing communication standard which allows description and control of the household appliance in accordance with semantic protocols is implemented reliably and inexpensively.

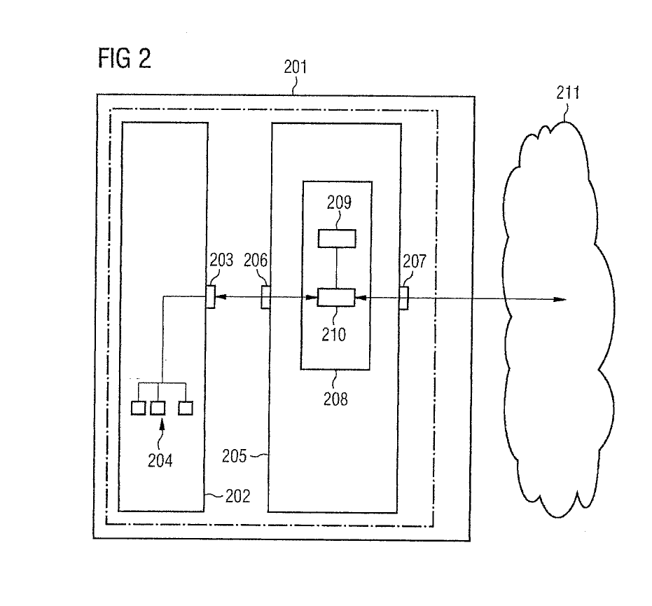

A domestic appliance arrangement 201 in accordance with a first exemplary embodiment of the invention, as shown in FIG. 2, has a washing machine 202 as an exemplary domestic appliance and an interface coupling device 205.

The washing machine 202 has a communication interface 203 and a plurality of sensors/actuators 204 which are coupled to the communication interface 203 and can use it to send and receive signals.

The interface coupling device 205 has a first interface 206, a second interface 207 and a protocol conversion unit 208, which for its part has a memory device 209 and a processor 210 coupled to the memory device 209. The processor 210 is also coupled to the first interface 206 and to the second interface 207. The memory device 209 is used to control a protocol conversion program code which is executed by the processor 210.

The text below describes the way in which the domestic appliance arrangement 201 designed in this manner works.

The washing machine 202 and the interface coupling device 205 communicate in accordance with a domestic appliance communication protocol which the domestic appliance “understands”. In the present arrangement, the domestic appliance communication protocol is based on the European Installation Bus (EIB) standard, which is widespread in domestic installation today. Alternatively, it may be another protocol standard, such as one from the systems EHS or LCN, or a proprietary protocol.

In the present exemplary embodiment, the washing machine 202 has been integrated into a UPnP network 211 in which communication is effected in accordance with the semantic UPNP standard. This integration is implemented by incorporating the washing machine 202 into the UPnP network 211 via the second interface 207 using the interface coupling device 205. For this purpose, the protocol conversion unit 208 of the interface coupling device 205 performs protocol conversion from the EIB standard to the UPnP standard, i.e. protocol conversion from data which have been encoded in accordance with a protocol from the EIB standard to data which have been encoded in accordance with a protocol from the UPnP standard, and vice versa. This protocol conversion is implemented by virtue of the processor 210 executing the protocol conversion program code which is stored in the memory device 209, and which is set up such that signals which are received via the communication interface 203 of the washing machine 202 and the first interface 206 of the interface coupling device 205 and which have been encoded in accordance with a protocol from the EIB standard are converted in suitable fashion into corresponding signals which are based on a protocol from the UPNP standard and which are output via the second interface 207 of the interface coupling device 205 and hence made available to the UPnP network 211. By way of example, these signals are signals from sensors which, by way of example, provide information about the supply of water, the water filling level, the rotation speed of the washing machine drum, the calcification state of the heating rods and the like.

Conversely, signals which are received from the UPNP network 211 via the second interface 207 are converted by the protocol conversion unit 208, to be more precise by the execution of the protocol conversion program code in the processor 210 of the protocol conversion unit 208, into corresponding signals based on the EIB standard which are then output via the first interface 206 of the interface coupling device 205 and the communication interface 203 to the washing machine 202, the signals transmitted to the washing machine 202 being able to actuate particular actuators in the washing machine 202. By way of example, such signals can be used to switch the heating system of the washing machine on or off, to control the rotation speed of the washing drum or to control the supply and drainage of water (operation of the wash pump).

The described technique of protocol conversion means that the combination of washing machine 202 and interface coupling device 205 on the second interface 207 appears as a full UPnP appliance. In accordance with the functionality of UPnP, the protocol conversion unit 208 implements identification of the washing machine 202 (or more precisely the combination which is formed by the washing machine 202 and the interface coupling device 205) by means of the appropriate UPnP functions Discovery (provides the function of locating a UPnP appliance using the Simple Service Discovery Protocol (SSDP) and Description (semantic description of the services provided using XML description files).

In addition, control of the washing machine 202 (or, concretely, of the “UPnP appliance”, which is formed by the washing machine 202 and the interface coupling device 205) is possible using the UPnP functions Control (control of a UPnP appliance by means of messages in accordance with the Simple Object Access Protocol (SOAP)) and Eventing (message about the state of a service or of a status variable for a UPnP appliance using the XML-based General Event Notification Architecture (GENA)).

Since the washing machine 202 appears as a UPnP appliance as a result of the second interface 207 of the interface coupling device 205, the washing machine 202 in the domestic appliance arrangement 201 can be incorporated into the UPnP network 211 and can be controlled in such a network like a UPnP appliance, for example using a computer which the UPnP network contains.

The processor 210 in the protocol conversion unit 205 should be powerful enough to be able to perform the described protocol conversion reliably and sufficiently quickly; by way of example, a 16-bit or 32-bit processor is provided.

In this exemplary embodiment, the memory device 209 is in the form of a nonvolatile, rewritable memory, e.g. in the form of an EEPROM. By way of example, this has the effect that a programming interface (not shown) on the interface coupling device, for example, can be used to update the protocol conversion program code or to adapt it for different standards of the domestic appliance communication protocol, that is to say for different washing machines in the example.

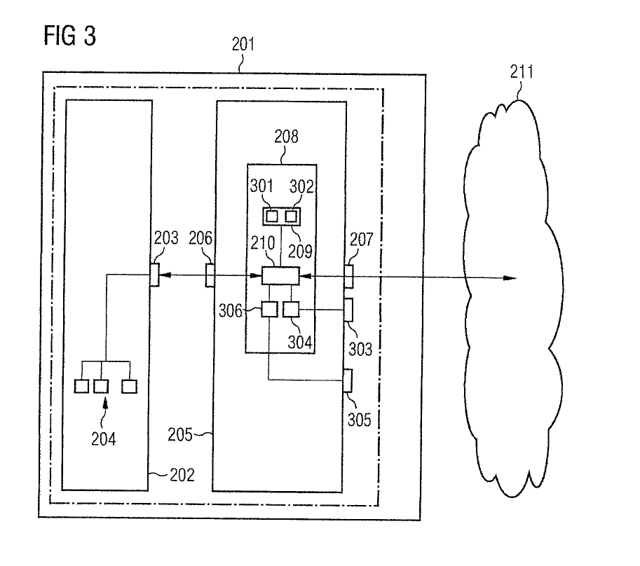

In a modification of the first embodiment, the protocol conversion unit 208 in a second embodiment of the domestic appliance arrangement 201, as shown in FIG. 3, is further set up such that the memory device 209 has a first submemory 301 and a second submemory 302, the first submemory 301 storing the protocol conversion program code and the second submemory 302 of the memory device 209 additionally storing a control program for controlling the washing machine.

Alternatively, both the protocol conversion program code and the control program may be stored in a common memory.

The control program for controlling the washing machine can be executed by the processor 210 and is a piece of application software for operation of the washing machine 202. For a user to interact with the control program, the interface coupling device 205 is provided with an input interface 303 and with an output interface 305. The input interface 303 may be a PS/2 interface, for example, to which input appliances, e.g. a keyboard and/or mouse, are connected for operating the control program. The input interface 303 is coupled to an input control unit 304, which for its part is coupled to the processor 210. By way of example, the output interface 305 is a monitor interface for connecting a monitor, the monitor interface being coupled to a graphics unit 306 in the protocol conversion unit, with the graphics unit 306 for its part being coupled to the processor 210.

Therefore, the interface coupling device 205 in this modified embodiment is used not only for the protocol conversion described above but also for executing a program for controlling the washing machine 202, with operator control actions which were originally performed on the switches/buttons of the washing machine now being able to be performed using the control program, for example.

Hence, in accordance with the second embodiment, the washing machine 202 can be controlled directly via the interface coupling device 205, so that control using an appliance within the UPnP network 211 to which the washing machine is also connected by means of the second interface 207 of the interface coupling device 205 is not imperative but continues to be possible.

In the embodiments shown up to now, the interface coupling device 205 was responsible for the full protocol conversion and—possibly—for the execution of a domestic appliance control program. For this reason, the processor 210 in the embodiments shown up to now may have considerable power, which also necessitates a considerable power consumption. Since it may be desirable to integrate the interface coupling device 205 as far as possible on or in a domestic appliance as an “embedded device”, this means that ultimately the domestic appliance itself may be equipped with powerful computer technology, which increases the costs for the domestic appliance in question, this being noticeable particularly in inherently simple and inexpensive domestic appliances. Furthermore, there may be situations in which it is not desirable or not even possible to equip the domestic appliance with powerful computer technology. This is particularly true for domestic appliances which are smaller and have simpler functionality than the washing machine considered to date.

In accordance with another embodiment of the invention, a domestic appliance arrangement is provided in which the domestic appliance or the interface coupling device arranged as far as possible in or on the domestic appliance has only reduced functionality.

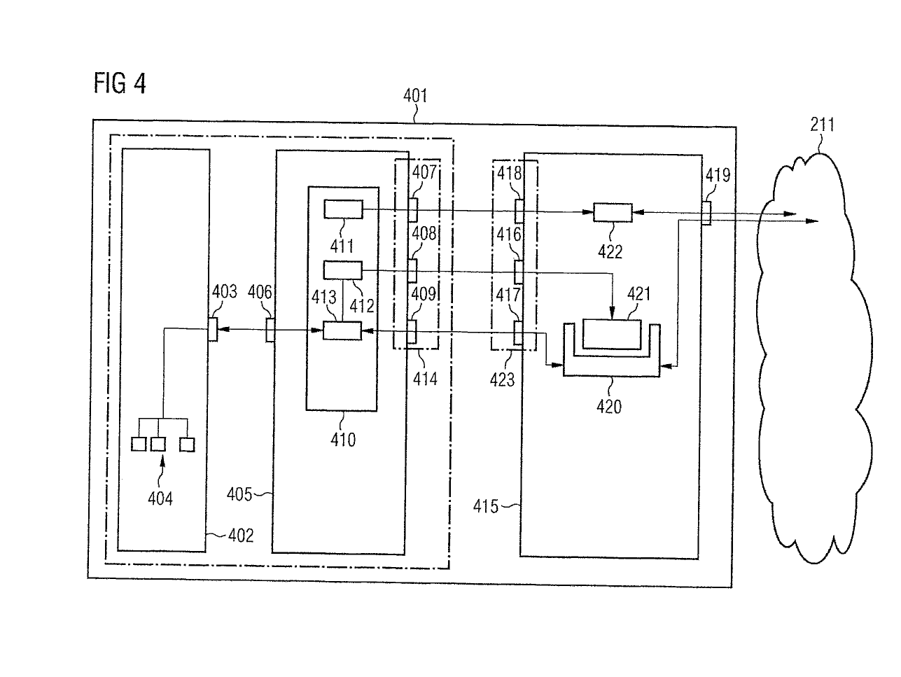

Accordingly, a third embodiment, shown in FIG. 4, has a domestic appliance arrangement 401 with a heating fan 402 as an exemplary domestic appliance, with an interface coupling device 405 and with a computer 415 as an exemplary external protocol conversion unit.

The heating fan 402 has a communication interface 403 and a plurality of sensors/actuators 404. By way of example, one sensor may detect the ambient temperature so that the heating system (heater coil) of the heating fan can be switched on and off on the basis of the ambient temperature, for example. An actuator (switch) can perform the switching on/off.

The interface coupling device 405 has a first interface 406, a second interface 407, a first protocol conversion program code transmission interface 408, a third interface 409 and a protocol conversion unit 410.

The protocol conversion unit 410 has an initialization unit 411, a first memory unit 412 and an 8-bit microprocessor as a first control unit 413.

The communication interface 403 is coupled to the plurality of sensors/actuators 404 in the heating fan 402. The heating fan 402 uses the communication interface 403 and the first interface 406 to communicate with the interface coupling device 405 in accordance with a domestic appliance communication protocol, for example a protocol in accordance with the EIB standard. The microprocessor 413 is coupled to the first interface 406 and to the third interface 409, the initialization unit 411 is coupled to the second interface 407, and the first memory unit 412 is coupled to the first protocol conversion program code transmission interface 408. The first memory unit 412 stores a protocol conversion program code which, when executed, performs protocol conversion from the EIB standard to the UPnP standard, i.e. protocol conversion from data which have been encoded in accordance with a protocol from the EIB standard to data which have been encoded in accordance with a protocol from the UPnP standard, and vice versa, as already explained for the first embodiment.

The interface coupling device 405 is integrated in or on the heating fan 402 as an embedded device, for example.

The computer 415 as external protocol conversion unit has a second protocol conversion program code transmission interface 416, a fourth interface 417, a fifth interface 418, a sixth interface 419, a processor 420 as processing unit, a hard disk 421 as second memory unit 421 and a second control unit 422.

The processor 420 is coupled to the fourth interface 417 and to the sixth interface 419, the hard disk 421 is coupled to the second protocol conversion program code transmission interface 416, and the second control unit 422 is coupled to the fifth interface 418 and to the sixth interface 419.

The domestic appliance arrangement 401 designed in this manner is set up so that it is integrated into the UPNP network 211 via the sixth interface 419.

To incorporate the heating fan 402 into the UPnP network 211, the initialization unit 411 is set up such that a communication link can be set up between said initialization unit 411 and the second control unit 422 in the computer 415 using the second interface 407 and the fifth interface 418, said communication link being able to be used to identify and semantically describe the heating fan 402 in the UPnP network via the sixth interface 419. The second control unit 422, which has the functionality of a UPnP control point, can thus discover the existence and the properties of an appropriate domestic appliance, in this case that is to say the heating fan 402 or more precisely the heating fan interface coupling device combination, using the initialization unit 411.

That is to say that, in accordance with the functionality of UPnP, the initialization unit 411 implements only the identification of the heating fan 402 through the appropriate functions Discovery (location of an UPnP appliance using the Simple Service Discovery Protocol (SSDP)).

Furthermore, the first memory unit 412 stores a protocol conversion program code which can perform a protocol conversion, as has already been illustrated for the embodiments described above. The protocol conversion program code can be downloaded from the first memory unit 412 of the domestic appliance's interface coupling device 405 onto the hard disk 421 of the computer 415 and can be executed by the processor 420. In other words, the processor 420 implements every protocol conversion which—within the context of UPnP—goes beyond the initial communication (Discovery and Description), that is to say that the interface coupling device 405 carries a “software proxy” in the first memory unit 412 which, when executed, implements a protocol conversion, but this execution does not take place in the protocol conversion unit 410 local to the appliance but rather in the remote computer 415. Accordingly, signals which correspond to the EIB standard are transmitted from the heating fan 402 by means of the communication interface 403 and the first interface 406 to the microprocessor 413 in the interface coupling device 405 and from there by means of the third interface 409 and the fourth interface 417 to the computer 415. That is to say that the communication between the interface coupling device 405 and the computer 415 (between the third interface 409 and the fourth interface 417) complies with the EIB protocol standard.

By way of example, all communication between the interface coupling device 405 and the external protocol conversion unit 415 at physical level is in wireless form, e.g. in the form of an RF link.

In this exemplary embodiment, in which, as explained above, the protocol conversion is implemented in software which is executed by the processor 420 in the computer 415, no great technical demands are made on the initialization unit 411 and on the microprocessor 413, which in this case is in the form of a simple 8-bit microprocessor.

When the interface coupling device 405 is linked to the computer 415 wirelessly by way of example, the interface coupling device 405 is in the form of a transceiver overall, with the communication via the second interface 407, the first protocol conversion program code transmission interface 408 and the third interface 409 being in the form of wireless communication at a physical level, for example via one and the same first wireless interface 414 (e.g. RF interface, infrared interface). In the same way, the fourth interface 417, the fifth interface 418 and the second protocol conversion program code transmission interface 416 are in physical form, for example all in the form of one and the same second wireless interface 423 (e.g. RF interface, infrared interface).

The computation-intensive protocol conversion which—within the context of UPNP—implements the functions Control and Eventing (see above for explanations of these functions), takes place in the computer 415, which can easily be provided with sufficiently great computation power through the choice of a suitable processor 420, for example a 16-bit or 32-bit processor.

The interface coupling device 405 can therefore be of small, energy-saving and inexpensive design and can comfortably also be integrated in a relatively small household appliance as an “embedded device”, since the protocol conversion, which concerns the actual control of the domestic appliance (that is to say Control and Eventing here in the case of UPnP), takes place in the computer 415 as the external protocol conversion unit. It is thus also possible to integrate smaller and less expensive domestic appliances into the UPNP environment without needing to equip these appliances themselves with respective complex computer technology. Rather, the computation-intensive operations of protocol conversion and hence of linking a household appliance which communicates in accordance with an arbitrary, even proprietary, standard are executed by the computer 415 in a semantic environment, as in this case UPnP.

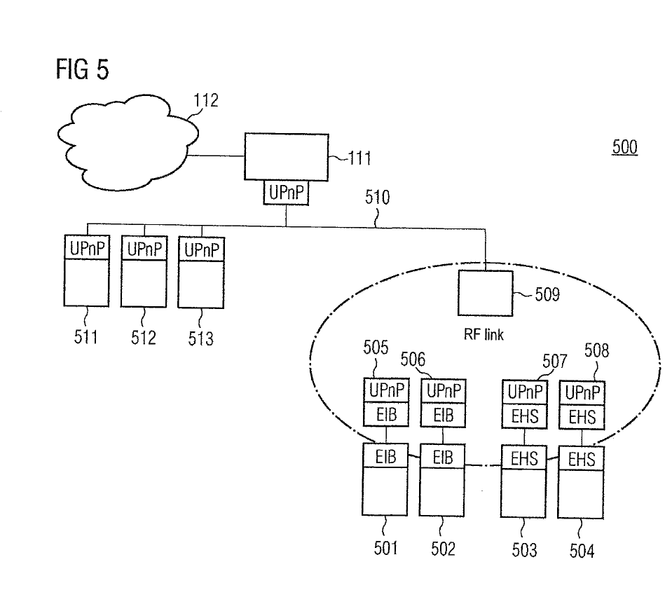

FIG. 5 shows an example of a network 500 in which the domestic appliance arrangement 401 in accordance with the third embodiment of the invention is used.

To allow all-embracing networking of terminals 501 to 504 based on different network standards, which terminals can each be identified as an appliance, such as the heating fan 402 from FIG. 4 or the washing machine 202 from FIG. 2 or FIG. 3, it is possible to use mini bridges 505 to 508, based on Sindrion™ technology, in each individual appliance. These mini bridges provide the appliance with a link to a specific automation standard and are connected by means of a wireless link to a terminal (PC, set top box) 509 onto which a software plug-in is downloaded which the terminal uses to provide the outside with full UPNP functionality for the respective connected appliance in the network. These Sindrion™ mini bridges accordingly have the structure and functionality of the interface coupling device 405 discussed within the third embodiment. The Sindrion™ mini bridges 505 to 508 can therefore each be identified as an interface coupling device 405 as shown in FIG. 4.

With reference to FIG. 5, a UPnP network 510 firstly has a computer 511, an audio/video centre 512 and a Voice-Over-IP appliance 513 connected to it which actually have UPNP capability and can therefore be connected directly to the UPNP network 510. In addition, a lamp 501 and a television 502, which communicate in accordance with the EIB standard, are coupled to Sindrion™ mini bridges 505 and 506. Furthermore, a washing machine 503 and a refrigerator 504, which communicate in accordance with the EHS standard, are coupled to Sindrion™ mini bridges 507 and 508. The Sindrion™ mini bridges 505 to 508 are connected to the terminal (PC, set top box) 509, which for its part is integrated in the UPnP network 510, by means of a wireless link, in this case by means of an RF radio link, for example. This means that each Sindrion™ mini bridge 505 to 508 (respectively corresponds to the interface coupling device 405 from FIG. 4) has a “software proxy” (corresponds to the protocol conversion code in the first memory unit 412 in FIG. 4) which is transmitted to the terminal (computer) 509 and executed therein, as discussed in detail above in connection with the third embodiment of the invention.

In addition, the UPnP network 510 is coupled by means of the gateway 111 to a wide area network (WAN), for example the Internet 112, which means that the UPNP network 510 can also communicate beyond its boundaries with other networks by means of the Internet 112.

For an appliance manufacturer, the programmable Sindrion™ mini bridges allow simple wireless linking of the existing appliance interfaces to the UPNP standard. The Sindrion™ mini bridges are inexpensive and are distinguished by low power consumption. The use of dedicated mini bridges also prevents a malfunction from being able to affect the entire network.

Thus, already existing electrical or electronic appliances involving different appliance interfaces or automation standards can be incorporated into an encompassing UPnP network if the manufacturer installs programmable Sindrion™ mini bridges. This allows directly applicable, inexpensive, fail safe, standardized and semantically controllable automation.

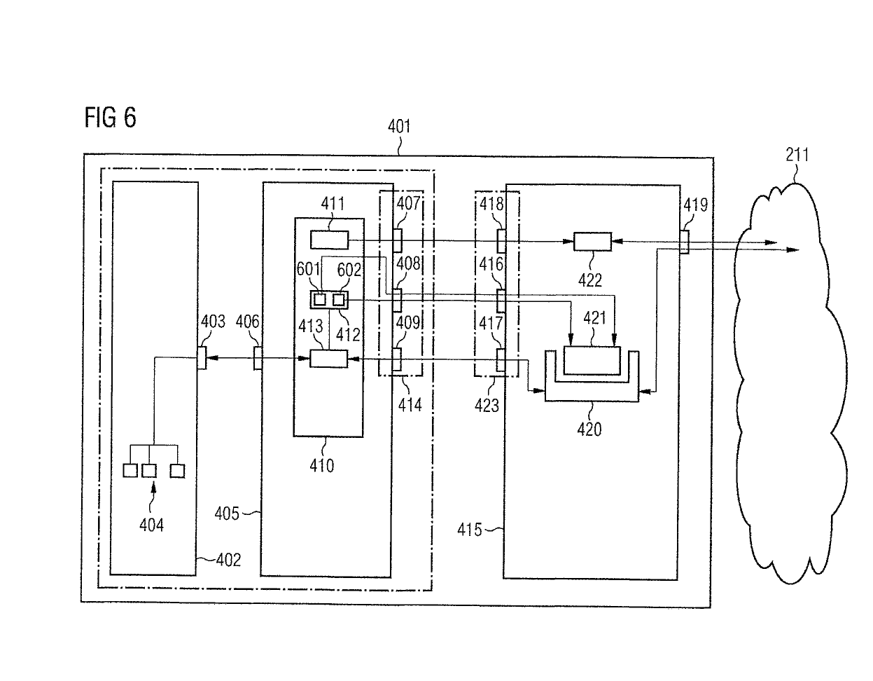

FIG. 6 shows a fourth embodiment of the invention as a modification of the third embodiment shown in FIG. 4. In the fourth embodiment, the first memory device 412 in the protocol conversion unit 410 of the domestic appliance's interface coupling device 405 has a first submemory 601 and a second submemory 602, the first submemory 601 storing the protocol conversion program code and the second submemory 602 of the memory device 412 additionally storing a control program for controlling the washing machine.

Alternatively, both the protocol conversion program code and the control program may be stored in a common memory, as already illustrated in the modification of the first embodiment in connection with FIG. 3.

The control program can, like the protocol conversion program code, be loaded from the first memory device 412 of the protocol conversion unit in the interface coupling device 405 into the second memory unit 421 of the computer 415 using the first protocol conversion program code transmission interface 408 and the second protocol conversion program code transmission interface 416 and can be executed by the processor 420. As in the second embodiment, the control program is a piece of application software for operator control of the domestic appliance, that is to say in this case the heating fan 402. In this case, a user interacts with the control program using appropriate input appliances (mouse, keyboard) and output appliances (monitor), which are part of the computer 415, or using another appliance which is incorporated in the UPNP network 211. Therefore, the computer 415 as an external protocol conversion unit is, in this modified embodiment, used not only for the protocol conversion described above, relocated from the domestic appliance's interface coupling device 405, but also to execute a piece of software for controlling the heating fan, with operator control actions which were originally performed on the heating fan itself now being able to be executed by means of the control program. This may involve switching the heating fan on and off or setting the heating level, for example.

On the other hand, the heating fan 402 can use the interface coupling device 405 to report a signal encoding the temperature to the computer 415 executing the control program, with the control program being able to indicate the relevant temperature value, for example.

Control can therefore be executed directly by means of the computer 415 without the need for a further control appliance within the UPNP network 211. By using the control program executed in the computer 415, the heating fan 402 can be controlled by the fourth, third and first interfaces 417, 409 and 406 and via the communication interface 403 of the heating fan 402.

Instead of the computer 415, the external protocol conversion unit used may also be a laptop, a webpad, a personal digital assistant (PDA) or else a mobile radio telephone or any apparatus which is capable of providing the processing power required for executing the protocol conversion program code and possibly the control program.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes that come within the meaning and range of equivalency of the claims are intended to be embraced.

What is claimed is:

1. A domestic appliance arrangement, comprising:
precisely one domestic appliance which can communicate in accordance with a domestic appliance communication protocol;
an interface coupling device which is associated with the precisely one domestic appliance and which is coupled to the one domestic appliance, wherein the interface coupling device comprises:
a first interface configured to provide communication in accordance with the domestic appliance communication protocol;
a second interface configured to provide communication in accordance with at least one semantic communication protocol, wherein the at least one semantic communication protocol can be used to:
detect at least one domestic appliance connected to the interface coupling device; and
semantically describe properties of at least one domestic appliance connected to the interface coupling device; and
a protocol conversion unit configured to map data which have been encoded in accordance with the domestic appliance communication protocol onto data which have been encoded in accordance with the at least one semantic communication protocol and/or to map data which have been encoded in accordance with the at least one semantic communication protocol onto data which have been encoded in accordance with the domestic appliance communication protocol.

2. The domestic appliance arrangement according to claim 1, wherein the domestic appliance is a domestic appliance selected from the group consisting of a refrigerator, a stereo system, a dishwasher, a washing machine, a laundry dryer, a microwave oven, a cooker, a lighting system, and a heating system.

3. The domestic appliance arrangement according to claim 1, wherein the protocol conversion unit comprises:
a memory device configured to store a protocol conversion program code; and
a processor configured to execute the protocol conversion program code,
wherein the execution of the protocol conversion program code implements the mapping of data which have been encoded in accordance with the domestic appliance communication protocol onto data which have been encoded in accordance with the at least one semantic communication protocol and/or the mapping of data which have been encoded in accordance with the at least one semantic communication protocol onto data which have been encoded in accordance with the domestic appliance communication protocol.

4. The domestic appliance arrangement according to claim 1, wherein the at least one semantic communication protocol is further used to provide at least one additional function for controlling the domestic appliance.

5. The domestic appliance arrangement according to claim 3, wherein the protocol conversion unit is further configured to execute a domestic appliance control program stored in the memory device to control the domestic appliance via the first interface.

6. The domestic appliance arrangement according to claim 5, wherein the memory device comprises a first submemory and a second submemory, and wherein the first submemory is configured to store the protocol conversion program code and the second submemory is configured to store the domestic appliance control program.

7. The domestic appliance arrangement according to claim 1, wherein the interface coupling device further comprises an input interface and an output interface.

8. The domestic appliance arrangement according to claim 1, wherein the protocol conversion unit comprises:
an initialization unit which is configued, via the second interface, to:
detect at least one domestic appliance connected to the interface coupling device; and
semantically describe properties of at least one domestic appliance connected to the interface coupling device; and
a first memory device configured to store a protocol conversion program code,
wherein the interface coupling device further comprises:
a first protocol conversion program code transmission interface configured to transmit the protocol conversion program code to an external protocol conversion unit; and
a third interface configured to provide communication in accordance with the domestic appliance communication protocol between the interface coupling device and an external protocol conversion unit.

9. The domestic appliance arrangement according to claim 8,
wherein the first memory device further comprises a domestic appliance control program stored therein to control the domestic appliance, and
wherein the first protocol conversion program code transmission interface is further configured to transmit the domestic appliance control program to an external protocol conversion unit.

10. The domestic appliance arrangement according to claim 9, wherein the first memory device comprises a first submemory and a second submemory, and wherein the first submemory stores the protocol conversion program code and the second submemory stores the domestic appliance control program.

11. The domestic appliance arrangement according to claim 8, further comprising an external protocol conversion unit configured to execute the protocol conversion program code.

12. The domestic appliance arrangement according to claim 11, wherein the external protocol conversion unit comprises:
a second protocol conversion program code transmission interface configured to receive the protocol conversion program code from the interface coupling device;
a fourth interface configured to provide communication in accordance with the domestic appliance communication protocol;
a second memory device configured to store the received protocol conversion program code;
a processing device configured to execute the received protocol conversion program code, wherein the execution of the protocol conversion program code implements the mapping of data which have been encoded in accordance with the domestic appliance communication protocol onto data which have been encoded in accordance with the at least one semantic communication protocol and/or the mapping of data which have been encoded in accordance with the at least one semantic communication protocol onto data which have been encoded in accordance with the domestic appliance communication protocol, and wherein at least one of the at least one semantic communication protocol is further used to provide an additional function for controlling the domestic appliance; and
a fifth interface which is used to provide communication in accordance with the at least one semantic communication protocol.

13. The domestic appliance arrangement according to claim 12, wherein:
the second protocol conversion program code transmission interface is further configured to receive the domestic appliance control program from the interface coupling device,
the second memory device is further configured to store the received domestic appliance control program, and
the processing device is further configured to execute the domestic appliance control program for controlling the domestic appliance via the fourth, third and first interfaces.

14. The domestic appliance arrangement according to claim 1, wherein the external protocol conversion unit is selected from the group of devices consisting of a workstation, a personal computer, a laptop, a set top box, a home Internet gateway, a webpad, a personal digital assistant, and a mobile radio telephone.

15. The domestic appliance arrangement according to claim 1, wherein the at least one semantic communication protocol is a semantic communication protocol in accordance with the UPnP standard.

16. The domestic appliance arrangement according to claim 15, wherein the at least one semantic communication protocol comprises the Simple Service Discovery Protocol and/or Hypertext Transfer Protocol.

17. The domestic appliance arrangement according to claim 4, wherein the at least one semantic communication protocol is a semantic communication protocol in accordance with the UPnP standard which implements the functions of Control and Eventing in accordance with UPnP.

18. The domestic appliance arrangement according to claim 17, wherein the at least one semantic communication protocol comprises the Simple Object Access Protocol (SOAP) and the General Event Notification Architecture (GENA).

19. An interface coupling device which can be coupled to a domestic appliance, comprising:
a first interface configured to provide communication in accordance with a domestic appliance communication protocol;
a second interface configured to provide communication in accordance with one or more semantic communication protocol(s), wherein the one or more semantic communication protocols can be configured to:
detect at least one domestic appliance connected to the interface coupling device; and
semantically describe properties of at least one domestic appliance connected to the interface coupling device,
a protocol conversion unit configured to map data which have been encoded in accordance with the domestic appliance communication protocol onto data which have been encoded in accordance with the one or more semantic communication protocol(s) and/or to map data which have been encoded in accordance with the one or more semantic communication protocol(s) onto data which have been encoded in accordance with the domestic appliance communication protocol.

20. A method for controlling precisely one domestic appliance in a domestic appliance arrangement comprising the precisely one domestic appliance and an interface coupling device associated with the precisely one domestic appliance, the method comprising:
coupling the precisely one domestic appliance to the interface coupling device using a communication interface of the domestic appliance and a first interface of the interface coupling device, which allows communication between the domestic appliance and the interface coupling device;
detecting at least one domestic appliance connected to the interface coupling device and semantically describing properties of at least one domestic appliance connected to the interface coupling device using communication in accordance with at least one semantic communication protocol via a second interface provided on the interface coupling device;
mapping data which have been encoded in accordance with the domestic appliance communication protocol onto data which have been encoded in accordance with the at least one semantic communication protocol and/or mapping data which have been encoded in accordance with the at least one semantic communication protocol onto data which have been encoded in accordance with the domestic appliance communication protocol using a protocol conversion unit;
coupling the protocol conversion unit to the first interface and to the second interface of the interface coupling device; and
establishing a communication link between the domestic appliance and the second interface via the communication interface of the domestic appliance and of the first interface of the interface coupling device.

21. A domestic appliance arrangement, comprising:
precisely one domestic appliance for communicating in accordance with a domestic appliance communication protocol;
an interface coupling means, which is associated with the precisely one domestic appliance and which is coupled to the one domestic appliance, for providing communication in accordance with the domestic appliance communication protocol, and for providing communication in accordance with at least one semantic communication protocol, wherein the at least one semantic communication protocol can be used to:
detect at least one domestic appliance connected to the interface coupling device; and
semantically describe properties of at least one domestic appliance connected to the interface coupling device; and
a protocol conversion means for mapping data which have been encoded in accordance with the domestic appliance communication protocol onto data which have been encoded in accordance with the at least one semantic communication protocol and/or for mapping data which have been encoded in accordance with the at least one semantic communication protocol onto data which have been encoded in accordance with the domestic appliance communication protocol.
